(19) United States
(12) Patent Application Publication
(10) Pub. No.: US 2026/0087504 A1
(43) Pub. Date: Mar. 26, 2026

(54) ENVIRONMENTAL PROJECT EMISSION MONITORING AND ASSET DISTRIBUTION SYSTEMS AND METHODS

(71) Applicant: Xofia Inc., Houston, TX (US)

(72) Inventor: Carlos A. Sanmiguel, Houston, TX (US)

(21) Appl. No.: 19/337,398

(22) Filed: Sep. 23, 2025

Related U.S. Application Data
(60) Provisional application No. 63/698,480, filed on Sep. 24, 2024.

(51) Int. Cl. G06Q 30/018; G06Q 10/10

(52) U.S. Cl. CPC G06Q 30/018; G06Q 10/103

(57) ABSTRACT

An environmental emission reduction system obtaining industry emissions data; determining, based on the emissions data, project emission risk models operable to determine a project emission risk assessment for a project based on project data; identifying, based on project data for a project, a project emission risk model of models; determining, based on application of the project data to the model, a project emission risk assessment; determining, based on the project emission risk assessment, a self-executing emission monitoring agreement for the project that defines emission metrics for the project; and conditional asset distributions; obtaining observed values of the monitored emission metrics; determining, based on application of the observed values of the monitored emission metrics to the self-executing emission monitoring agreement, whether an emission asset distribution event has occurred; and distributing, in response to determining that one has occurred, an emission asset distribution to one or more member entities.

### RELATED APPLICATIONS

This application claims benefit of and priority to U.S. Provisional Patent application No. 63/698,480 titled “ENVIRONMENTAL PROJECT EMISSION MONITORING AND ASSET DISTRIBUTION SYSTEMS AND METHODS” and filed Sep. 24, 2024, which is hereby incorporated by reference in its entirety.

### FIELD

Embodiments relate generally to performance-based execution and more particularly to systems and methods for assessing and implementing emission performance-based mitigation operations.

### BACKGROUND

Green technology project financing has emerged as a pivotal mechanism for advancing sustainable development initiatives. Such mechanisms are generally designed to channel funds into projects that directly contribute to reducing environmental impacts, such as those aimed at lowering greenhouse gas emissions. Example projects include renewable energy installations, enhancements in energy efficiency, and the deployment of carbon capture technologies. Identifying, financing, and employing green technology projects enables the scaling of these environmentally beneficial projects, making it an essential tool in the global effort to combat climate change.

### SUMMARY

Achieving target emission reductions can be a difficult and unpredictable task, and the uncertainty surrounding the achievement of anticipated emission reductions can create significant challenge in emission reduction projects and associated green project financing. Various risks, including regulatory changes, technological underperformance, and market fluctuations, can impede the realization of projected environmental benefits. These risks threaten the achievement of environmental objectives and can introduce financial instability, potentially diminishing investor confidence and, in turn, creating an impediment to the success and advancement of green technologies. To address these concerns, it is crucial to develop comprehensive system that incorporates risk assessment and management frameworks to effectively mitigate these uncertainties, ensuring that environmental objectives are successfully met, and financial incentives remain in place to encourage the continued advancement of green technologies.

Conventional green project financing and emissions monitoring approaches suffer from significant technical limitations. For example, they rely heavily on fragmented data reporting, manual verification, and centralized recordkeeping, which are prone to inaccuracy, manipulation, and latency. These deficiencies create a fundamental technical problem—there is no reliable, automated, and tamper-resistant mechanism for validating emissions performance of projects and enforcing compliance obligations in real time. The disclosed embodiments provide a technical solution to this problem by, for example, integrating verified sensor-derived operational data with predictive emissions risk models, and encoding the resulting performance obligations into self-executing agreements deployed on a distributed ledger execution environment. By doing so, the system provides a technical solution that ensures secure, autonomous, and verifiable enforcement of emissions performance terms and automated distribution of digital assets, thereby improving reliability, scalability, and integrity of environmental compliance monitoring.

Provided are embodiments for accurately assessing and implementing performance-based technologies, such as green technologies. For example, certain embodiments employ an environmental emission reduction system that is operable to determine environmental risk models (e.g., project emission risk models) based on industry data obtained from one or more industry sources (e.g., industry emissions data obtained from various emission sensitive facilities and projects). The environmental emission reduction system may, in response to receiving project data for a new or existing project (e.g., project data for a new emission regulated facility or process), identify a relevant environmental risk model from the environmental risk models determined, and apply the project data received to the project risk model to generate a corresponding project risk assessment (e.g., apply the project data for the new emission regulated facility or process to a corresponding project emission risk model to generate a corresponding project emission risk assessment for the project). The environmental emission reduction system may determine, based on the corresponding project risk assessment, an emission monitoring agreement (e.g., a self-executing emission monitoring smart contract) and premium value for implementing the agreement (e.g., a premium to be paid by an operator of project to implement the self-executing emission monitoring smart contract), the agreement can be deployed in response to satisfaction of the premium and is operable to automatically conduct an asset distribution (e.g., a distribution of a fractional emission credit) to one or more members (e.g., to the operator or other interested parties) in response to operation of the project satisfying or not satisfying certain performance metrics (e.g., operational data for the project indicating a failure to satisfy emission standards defined in the contract).

Provided in some embodiment is an environmental emission reduction system including: a project management engine adapted to generate self-executing emission monitoring agreements, the project management engine adapted to: obtain, from one or more industry data sources, industry emissions data; determine, based on the industry emissions data obtained, one or more project emission risk models adapted to determine a project emission risk assessment for a project based on project data for the project; obtain, from a project manager, project data for a project; identify, based on the project data, a project emission risk model of the one or more project emission risk models that corresponds to the project; determine, based on application of the project data obtained to the project emission risk model identified, a project emission risk assessment for the project; and determine, based on the project emission risk assessment for the project, a self-executing emission monitoring agreement for the project, the self-executing emission monitoring agreement defining: project performance terms defining emission metrics for the project; and asset distribution terms defining one or more conditional asset distributions including an asset distribution to be conducted responsive to occurrence of an emission asset distribution event, occurrence of the emission asset distribution event determined based on observed values for the monitored emission metrics for the project; and an emission monitoring platform adapted to implement self-executing emission monitoring agreements, the emission monitoring platform adapted to: obtain, from a project emission monitor, emission performance data for the project, the emission performance data corresponding to observed values of the monitored emission metrics for the project; determine, based on application of the emission performance data obtained to the self-executing emission monitoring agreement, whether an emission asset distribution event has occurred; and distribute, in response to determining that an emission asset distribution event has occurred, an emission asset distribution to one or more member entities.

In some embodiments, the self-executing emission monitoring agreement includes computer code corresponding to the asset distribution terms and including conditional statements defining agreement terms corresponding to conducting the emission asset distribution to the one or more member entities in in response to occurrence of the emission asset distribution event. In some embodiments, the emission monitoring platform adapted to: store, on a distributed ledger peer-to-peer decentralized network, the computer code including conditional statements defining the conditional asset distributions, where the computer code stored on the distributed ledger peer-to-peer decentralized network is adapted to be executed to enforce the conditional statements defining the conditional asset distributions. In some embodiments, determining an emission asset distribution event has occurred includes the emission performance data determining that the emission performance data for the project indicates observed values of the monitored emission metrics for the project that fail to satisfy one or more thresholds for the monitored emission metrics for the project, and where the emission asset distribution to one or more member entities includes distribution of an asset having a value corresponding to failure of the observed values to satisfy the one or more thresholds for the monitored emission metrics for the project. In some embodiments, the asset includes an emission credit. In some embodiments, the emission monitor includes an independent third party entity that is operable to: obtain emission monitoring data corresponding to operational performance of the project; determine, based on assessment of the emission monitoring data, the emission performance data for the project; and provide, to the emission reduction monitoring platform, the emission performance data for use by the self-executing emission monitoring agreement. In some embodiments, further including a pool of emission credits, where the emission asset distribution includes a fractional emission credit of the pool of emission credits. In some embodiments, the project risk assessment for the project including a premium to implement the self-executing emission monitoring agreement, and the project management engine further adapted to: determine, based on the emissions performance data, updated project data; determine, based on application of the updated project data to the project emission risk model identified, an updated project emission risk assessment for the project; and determine, based on the updated project emission risk assessment for the project, an updated emission monitoring agreement for the project, the updated project emission risk assessment for the project including an updated premium to implement the updated emission monitoring agreement, and deploy an updated self-executing updated emission monitoring agreement responsive to receipt of the premium.

Provided in some embodiment is an environmental emission reduction method including: obtaining, from one or more industry data sources, industry emissions data; determining, based on the industry emissions data obtained, one or more project emission risk models adapted to determine a project emission risk assessment for a project based on project data for the project; obtaining, from a project manager, project data for a project; identifying, based on the project data, a project emission risk model of the one or more project emission risk models that corresponds to the project; determining, based on application of the project data obtained to the project emission risk model identified, a project emission risk assessment for the project; determining, based on the project emission risk assessment for the project, a self-executing emission monitoring agreement for the project, the self-executing emission monitoring agreement defining: project performance terms defining emission metrics for the project; and asset distribution terms defining one or more conditional asset distributions including an asset distribution to be conducted responsive to occurrence of an emission asset distribution event, occurrence of the emission asset distribution event determined based on observed values for the monitored emission metrics for the project; obtaining, from a project emission monitor, emission performance data for the project, the emission performance data corresponding to observed values of the monitored emission metrics for the project; determining, based on application of the emission performance data obtained to the self-executing emission monitoring agreement, whether an emission asset distribution event has occurred; and distributing, in response to determining that an emission asset distribution event has occurred, an emission asset distribution to one or more member entities.

In some embodiments, the self-executing emission monitoring agreement includes computer code corresponding to the asset distribution terms and including conditional statements defining agreement terms corresponding to conducting the emission asset distribution to the one or more member entities in in response to occurrence of the emission asset distribution event. In some embodiments, further including the following: storing, on a distributed ledger peer-to-peer decentralized network, the computer code including conditional statements defining the conditional asset distributions, where the computer code stored on the distributed ledger peer-to-peer decentralized network is adapted to be executed to enforce the conditional statements defining the conditional asset distributions. In some embodiments, determining an emission asset distribution event has occurred includes the emission performance data determining that the emission performance data for the project indicates observed values of the monitored emission metrics for the project that fail to satisfy one or more thresholds for the monitored emission metrics for the project, and where the emission asset distribution to one or more member entities includes distribution of an asset having a value corresponding to failure of the observed values to satisfy the one or more thresholds for the monitored emission metrics for the project. In some embodiments, the asset includes an emission credit. In some embodiments, further including the following: obtaining emission monitoring data corresponding to operational performance of the project; determining, based on assessment of the emission monitoring data, the emission performance data for the project; and providing the emission performance data for use by the self-executing emission monitoring agreement. In some embodiments, the emission asset distribution includes a fractional emission credit of the pool of emission credits. In some embodiments, the project risk assessment for the project including a premium to implement the self-executing emission monitoring agreement, the method further including: determining, based on the emissions performance data, updated project data; determining, based on application of the updated project data to the project emission risk model identified, an updated project emission risk assessment for the project; and determining, based on the updated project emission risk assessment for the project, an updated emission monitoring agreement for the project, the updated project emission risk assessment for the project including an updated premium to implement the updated emission monitoring agreement, and deploying an updated self-executing updated emission monitoring agreement responsive to receipt of the premium.

Provided in some embodiment is a non-transitory computer readable medium including program instructions stored thereon that are executable by a computer processor to cause the following operations for environmental emission reduction: obtaining, from one or more industry data sources, industry emissions data; determining, based on the industry emissions data obtained, one or more project emission risk models adapted to determine a project emission risk assessment for a project based on project data for the project; obtaining, from a project manager, project data for a project; identifying, based on the project data, a project emission risk model of the one or more project emission risk models that corresponds to the project; determining, based on application of the project data obtained to the project emission risk model identified, a project emission risk assessment for the project; determining, based on the project emission risk assessment for the project, a self-executing emission monitoring agreement for the project, the self-executing emission monitoring agreement defining: project performance terms defining emission metrics for the project; and asset distribution terms defining one or more conditional asset distributions including an asset distribution to be conducted responsive to occurrence of an emission asset distribution event, occurrence of the emission asset distribution event determined based on observed values for the monitored emission metrics for the project; obtaining, from a project emission monitor, emission performance data for the project, the emission performance data corresponding to observed values of the monitored emission metrics for the project; determining, based on application of the emission performance data obtained to the self-executing emission monitoring agreement, whether an emission asset distribution event has occurred; and distributing, in response to determining that an emission asset distribution event has occurred, an emission asset distribution to one or more member entities.

In some embodiments, the self-executing emission monitoring agreement includes computer code corresponding to the asset distribution terms and including conditional statements defining agreement terms corresponding to conducting the emission asset distribution to the one or more member entities in in response to occurrence of the emission asset distribution event. In some embodiments, the operations further including the following: storing, on a distributed ledger peer-to-peer decentralized network, the computer code including conditional statements defining the conditional asset distributions, where the computer code stored on the distributed ledger peer-to-peer decentralized network is adapted to be executed to enforce the conditional statements defining the conditional asset distributions. In some embodiments, determining an emission asset distribution event has occurred includes the emission performance data determining that the emission performance data for the project indicates observed values of the monitored emission metrics for the project that fail to satisfy one or more thresholds for the monitored emission metrics for the project, and where the emission asset distribution to one or more member entities includes distribution of an asset having a value corresponding to failure of the observed values to satisfy the one or more thresholds for the monitored emission metrics for the project. In some embodiments, the asset includes an emission credit. In some embodiments, the operations further including the following: obtaining emission monitoring data corresponding to operational performance of the project; determining, based on assessment of the emission monitoring data, the emission performance data for the project; and providing the emission performance data for use by the self-executing emission monitoring agreement. In some embodiments, the emission asset distribution includes a fractional emission credit of the pool of emission credits. In some embodiments, the project risk assessment for the project including a premium to implement the self-executing emission monitoring agreement, the method further including: determining, based on the emissions performance data, updated project data; determining, based on application of the updated project data to the project emission risk model identified, an updated project emission risk assessment for the project; and determining, based on the updated project emission risk assessment for the project, an updated emission monitoring agreement for the project, the updated project emission risk assessment for the project including an updated premium to implement the updated emission monitoring agreement, and deploying an updated self-executing updated emission monitoring agreement responsive to receipt of the premium.

Although certain embodiments are described in the context of monitoring emission characteristics of a crude oil refining process/facility type project for the purpose of illustration, embodiments may be employed regarding any suitable process, facility, or the like, such as product manufacturing, transportation systems/vehicles, farming, or the like, or any relevant characteristics, such as waste, noise, consumption of resources, or the like.

### BRIEF DESCRIPTION OF THE DRAWINGS

FIG. 1 is diagram that illustrates a project environment in accordance with one or more embodiments.

FIG. 2 is a flow diagram that illustrates a method of project management in accordance with one or more embodiments.

FIG. 3 is a diagram that illustrates an example computer system in accordance with one or more embodiments.

While this disclosure is susceptible to various modifications and alternative forms, specific example embodiments are shown and described. The drawings may not be to scale. It should be understood that the drawings and the detailed description are not intended to limit the disclosure to the particular form disclosed, but are intended to disclose modifications, equivalents, and alternatives falling within the spirit and scope of the present disclosure as defined by the claims.

### DETAILED DESCRIPTION

Provided are embodiments for accurately assessing and implementing performance based technologies, such as green technologies. For example, certain embodiments employ an environmental emission reduction system that is operable to determine environmental risk models (e.g., project emission risk models) based on industry data obtained from one or more industry sources (e.g., industry emissions data obtained from various emission sensitive facilities and projects). The environmental emission reduction system may, in response to receiving project data for a new or existing project (e.g., project data for a new emission regulated facility or process), identify a relevant environmental risk model from the environmental risk models determined, and apply the project data received to the project risk model to generate a corresponding project risk assessment (e.g., apply the project data for the new emission regulated facility or process to a corresponding project emission risk model to generate a corresponding project emission risk assessment for the project). The environmental emission reduction system may determine, based on the corresponding project risk assessment, an emission monitoring agreement (e.g., a self-executing emission monitoring smart contract) and premium value for implementing the agreement (e.g., a premium to be paid by an operator of project to implement the self-executing emission monitoring smart contract), the agreement can be deployed in response to satisfaction of the premium and is operable to automatically conduct an asset distribution (e.g., a distribution of a fractional emission credit) to one or more members (e.g., to the operator or other interested parties) in response to operation of the project satisfying or not satisfying certain performance metrics (e.g., operational data for the project indicating a failure to satisfy emission standards defined in the contract).

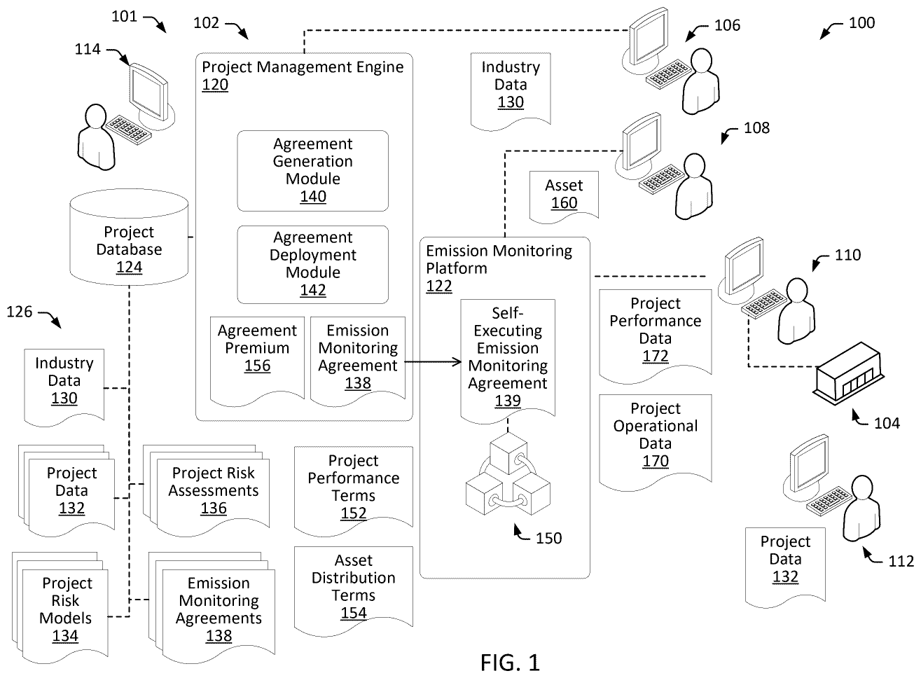

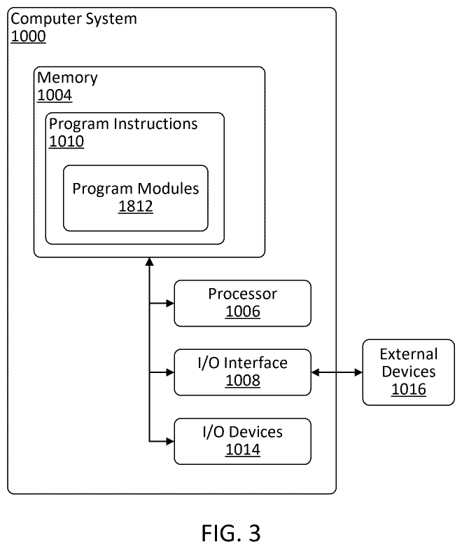

FIG. 1 is a diagram that illustrates a project environment (“environment”) 100 in accordance with one or more embodiments. In the illustrated embodiment, environment 100 includes an environmental emission reduction system 101 including a project management system (“management system”) 102, one or more monitored projects (“projects”) 104 (e.g., including a monitored facility, process, or the like), one or more industry data sources (“data sources”) 106, one or more project members (“members”) 108, one or more project monitors (“monitors”) 110, one or more project managers 112, and one or more management system operators (“operators”) 114. The management system 102 includes a project management engine 120, an emission monitoring platform 122, and a project database (“database”) 124 storing project assessment data 126, including industry data 130, project data 132, project risk models 134, project risk assessments 136, and emission monitoring agreements (“agreements”) 138. Project management engine 120 includes an agreement generation module 140 (e.g., operable to generate emission monitoring agreements 138) and an agreement deployment module 142 (e.g., operable to deploy asset distribution agreements 138 emission monitoring platform 122). Emission monitoring platform 122 includes an execution environment 150 (e.g., including a blockchain platform or the like) for deployment of self-executing emission monitoring agreements (“agreements”) 138. In some embodiments, management system 102 includes a computer system that is the same or similar to that of computer system 1000 described with regard to at least FIG. 3.

In some embodiments, management system 102 is operable to generate and deploy emission agreements relating to a project, to provide for automatic distribution of assets to certain entities based on performance of the project. For example, in the context of a project 104 being an environmentally sensitive project (an “environmental” project) having regulated emission standards that expose the project 104 to potential penalties for failing to satisfy the emission standards, agreement generation module 140 may be operable to generate a self-executing emission monitoring agreement 139 for the project 104 that defines project performance terms 152 (e.g., terms that include thresholds that correspond to some or all to the emission standards) and asset distribution terms 154 (e.g., terms that define terms for distribution of assets 160, such emission credits, to one or more members 108 based on failure of performance of project 104 to satisfy the project performance terms 152). In such an embodiment, agreement deployment module 142 may deploy the self-executing emission monitoring agreement 139 on emission monitoring platform 122, where the deployment includes execution of the agreement 139 in execution environment 150, such as a blockchain platform or the like. The execution may provide for continuous (e.g., every minute, half, hour, day, week, month, year, or the like) monitoring of relevant project performance data 164 for the project 104 (e.g., monitoring emission metrics or the like that are relevant to determining whether the project performance terms 152 are being satisfied) to determine whether the project 104 has satisfied (or failed to satisfy) relevant emission standards and, in response to determining that the project 104 has failed to satisfy project performance terms 152, conduct an automatic distribution of assets 160, such emission credits, to one or more members 108 pursuant to the asset distribution terms 154 of agreement 138.

Although certain embodiments refer to an item generally, embodiments may include descriptions that identify characteristics of the item. For example, the term “environmental” or “emission” may be used to characterize a given item. As an example, “environmental” or “emission” industry data may refer to industry data 130 that is indicative of one or more environmental or emission characteristics, respectively, such as an emission characteristic of an environmentally sensitive project, where an emission is a subset of environmental characteristics. Project “environmental” or “emission” risk model may refer to a project risk model 134 that accounts for “environmental” or “emission” risks, respectively. Project “environmental” or “emission” risk assessment may refer to a project risk assessment 136 that includes an assessment of “environmental” or “emission” risks, respectively.

In some embodiments, an emission monitoring agreement 138 (or an associated premium to employ the agreement 138) for a project is determined based on historical industry data and data for the project. For example, agreement generation module 140 may be operable to determine one or more project risk models 134 based on industry data 130 from one or more industry sources 106, and, in response to receiving project data 132 for a project 104, identify from the predetermined one or more project risk models 134, a corresponding project risk model 134 that matches or otherwise aligns with aspects of project 104, apply the received project data 132 to the identified risk model 134 to determine a corresponding an emission monitoring agreement 138 that defines project performance terms 152 and asset distribution terms 154, and determine a corresponding agreement premium 156 for deployment of the determined emission monitoring agreement 138 (e.g., determine a premium value to be paid by an operator of the project 104, such as a project manager 112, to provide for deployment of the agreement 138). As an example, where a project 104 includes a crude oil refining process/facility that is subject to governmental carbon dioxide (CO₂) emission standards, this may include agreement generation module 140 operable to determine, based on corresponding historical industry emissions data 130 from one or more industry sources 106, one or more project emission risk models 134 that include a given project emission risk model 134 for each of consumer automobile CO₂ generation, freight hauling truck CO₂ generation, container ship CO₂ generation, crude oil refining CO₂ generation, or the like, and, in response to receiving project data 132 for the project 104 that indicates that the project 104 includes a crude oil refining process/facility, identify from the various predetermined emission risk models 134, the project emission risk model 134 for crude oil refining CO₂ generation based on it matching or otherwise aligning with the crude oil refining process/facility of the project 104, apply the received project data 132 to the identified project emission risk model 134 for crude oil refining CO₂ generation to generate a corresponding project emission risk assessment 136 for the project 104 (e.g., including identification of emission-based risk factors), and determine, based on the corresponding project emission risk assessment 136 for the project 104, a corresponding emission monitoring agreement 138 that defines project performance terms 152 specifying acceptable CO₂ emission limits, including an overall facility/process CO₂ emission limit of 25,000 metric tons of CO₂ equivalent per year, a per barrel CO₂ emission limit of 500 kilograms of CO₂ per barrel of crude oil processed, and the like, and asset distribution terms 154 specifying distribution of assets in response to triggering events, including, for example, distribution of emission credits to offset overall facility/process CO₂ emissions of the project 104 that exceed the threshold of 25,000 metric tons of CO₂ equivalent per year (with half of the emission credits being distributed to a first member 108 and the other half of the emission credits being distributed to a second member 108), and including distribution of emission credits to offset per barrel CO₂ emissions that exceed the threshold of 500 kilograms of CO₂ per barrel of crude oil processed (with the emission credits being distributed to a first member 108), and so forth, and determine a corresponding agreement premium 156 of $1 million dollars/month to maintain deployment of the determined emission monitoring agreement 138.

In some embodiments, an emission monitoring agreement 138 is deployed in response to execution and funding of the agreement. For example, an emission monitoring agreement 138 may be deployed for execution in response to parties to the agreement executing the agreement and receipt of funding of the premium for the agreement 138. Continuing with the above example including an emission monitoring agreement 138 that involves management system 102, a crude oil refining project 104, and three members 108 as parties and a corresponding agreement premium 156 of $1 million dollars/month, emission monitoring agreement 138 may be deployed for execution in response to agents of management system 102 (e.g., an operator 114), the project 104 (e.g., a project manager 112), and the three members 108 signing (or “executing”) the emission monitoring agreement 138, and the initial installment of the premium 156 of $1 million dollars/month being paid or otherwise satisfied by, for example, by project manager 112 or the three members 108. In some embodiments, manager 112 includes a computer system that is the same or similar to that of computer system 1000 described with regard to at least FIG. 3. In some embodiments, a member 108 includes a computer system that is the same or similar to that of computer system 1000 described with regard to at least FIG. 3. In some embodiments, operator 114 includes a computer system that is the same or similar to that of computer system 1000 described with regard to at least FIG. 3.

In some embodiments, an emission monitoring agreement 138 is deployed on a suitable emission monitoring platform. For example, where an emission monitoring agreement 138 includes various terms, including project performance terms 152 and asset distribution terms 154, agreement deployment module 142 may be operable to convert associated terms of the emission monitoring agreement 138, including the project performance terms 152 and the asset distribution terms 154, or other terms, into code that can autonomously execute to conduct asset distributions in accordance with the asset distribution terms 154 when a triggering event occurs, such as when the project performance terms 152 are not satisfied. The code may, for example, be packaged in a corresponding self-executing emission monitoring agreement 139 (e.g., a smart contract) that is deployed in execution environment 150 of emission monitoring platform 122, such as a distributed ledger peer-to-peer (P2P) decentralized network (e.g., blockchain platform). In some embodiments, the execution environment 150 includes a directed acyclic graph of cryptographic hash pointers. This may include a Merkle tree forming blocks, linked via pointers (e.g., between tree roots) to form a chain of block. The directed acyclic graph may be operable to immutably store self-executing emission monitoring agreements and to enforce execution of the agreements by consensus validation across a plurality of computational nodes. Such a deployment may provide for autonomous execution of terms of an agreement, including automatically conducting distributions of assets based on observed emission performance for a project. Continuing with the above example, this may include agreement deployment module 142 generating a self-executing emission monitoring agreement 139 that includes code to monitor overall facility/process CO₂ emissions and per barrel CO₂ emissions for the crude oil refining project 104, and, if overall facility/process CO₂ emissions are determined to exceed the threshold of 25,000 metric tons of CO₂ equivalent per year, to distribute emission credits to offset the overage (with half of the emission credits being distributed to the first member 108 and the other half of the emission credits being distributed to the second member 108), and, if per barrel CO₂ emissions are determined to exceed the threshold of 500 kilograms of CO₂ per barrel of crude oil processed, to distribute emission credits to offset the overage (with the emission credits being distributed to the first member 108), and so forth.

In some embodiments, execution environment 150 includes a distributed ledger peer-to-peer (P2P) decentralized network. Continuing with the prior example, execution environment 150 may include a blockchain platform on which the self-executing emission monitoring agreement 139 is executed. In some embodiments, execution environment 150 is a cryptographically secured, immutable, and consensus-driven distributed ledger system, architected to function across a decentralized peer-to-peer network of computational nodes, where each node independently validates and verifies transactions through a collective protocol-driven mechanism, ensuring transparency, redundancy, and resistance to single points of failure. The structure may operate without centralized authority, relying instead on complex consensus algorithms, such as Proof of Work (PoW) or Proof of Stake (POS), which facilitate the autonomous validation of sequentially ordered blocks containing timestamped transactional data, thereby establishing a tamper-resistant, auditable, and trustless environment for the secure exchange of digital assets or information.

In some embodiments, a self-executing emission monitoring agreement 139 is informed by project performance data 170 supplied by monitor 110. For example, where a self-executing emission monitoring agreement 139 incorporates project performance terms 152 reliant on assessment of corresponding performance metrics, monitor 110 may be an intermediary entity operated independent of emission monitoring platform 122 and a project 104, that is operable to collect project operational data 170 that is indicative of the operational performance of the project 104, and determine, based on the collected project operational data 170, corresponding project performance data 172 that may include, for example, values or other indications of the performance metrics on which project performance terms 152 are reliant. Continuing with the prior example, including a self-executing emission monitoring agreement 139 for a crude oil refining project 104 that is reliant on metrics for annual overall facility/process CO₂ emissions and per barrel CO₂ emissions, monitor 110 may be an intermediary entity operated independent of emission monitoring platform 122 and the project 104, that is operable to collect project operational emission data 170, including rate of CO₂ emissions and a rate of oil production directly from CO₂ and oil flowrate sensors located in the crude oil refining process/facility of project 104, and determine, based on the collected project operational emission data 170, corresponding project emission performance data 172 including, for example, emission metrics (e.g., quantitative values) for annual overall facility/process CO₂ emissions and per barrel CO₂ emissions. As described, monitor 110 may, in turn, provide the project emission performance data 172 to emission monitoring platform 122, which can act as an oracle to provide relevant project emission performance data 172 to self-executing emission monitoring agreement 139 for assessment.

In some embodiments, a distribution of an asset 160 is performed based on project performance data and associated performance terms and asset distribution terms incorporated into a self-executing emission monitoring agreement. For example, where a self-executing emission monitoring agreement 139 incorporates project performance terms 152 that define a triggering event based on performance metrics not satisfying (or satisfying) a performance requirement, and an asset distribution terms 154 specifying distribution of assets in response to triggering events, in response to a determination that project performance data 152 include or otherwise indicates performance metrics not satisfying (or satisfying) the performance requirement, a distribution of asset 160 may be conducted in accordance with the incorporated asset distribution terms 154. Continuing with the above example, where project operational emission data 170 collected by monitor 110 indicates 30,000 metric tons of CO₂ equivalent was produced by the crude oil refining process/facility of project 104 and the crude oil refining process/facility of the project 104 maintained an average of 450 kilograms of CO₂ per barrel of crude oil processed for the year, monitor 110 may determine an overall facility/process CO₂ emission metric of 30,000 metric tons for the past year and a CO₂ per barrel of crude oil processed of 450 kilograms for the past year, and send project emission performance data 164 to emission monitoring platform 122 (which operates as an oracle to inform execution of self-executing emission monitoring agreement 139). By way of execution of agreement 139, it may be determined of that the project 104 satisfied the CO₂ per barrel of crude oil processed requirement (e.g., based on the CO₂ per barrel of crude oil of 450 kilograms being below the 450 kilograms threshold) and that the project 104 did not satisfy the overall facility/process CO₂ emission requirement (e.g., based on the overall facility/process CO₂ emission 30,000 metric tons being 5,000 metric tons above the 25,000 metric tons threshold). By way of execution of the agreement 139, the failure to satisfy the overall facility/process CO₂ emission requirement may be determined to be an asset distribution trigger event, it may be determined that 5,000 emission credits are needed to offset the 5,000 metric ton excess emission, and a distribution (or “payout”) of 2,500 of the emission credits to the first member 108 and the other 2,500 of the emission credits to the second member 108 may be conducted.

In some embodiments, emission monitoring agreements, premiums and the like may be updated based on updated project data. For example, updated project data 132, including updated project operational data 170 or project performance data 172, may be provided to project management engine 120, and project management engine 120 may, in turn, generate and deploy and updated emission monitoring agreement 138, based on the updated project data 132, in manner similar to that described here. Continuing with the prior example, project manager 112 or monitor 110 may send, to project management engine 120, updated project data 132 that is indicative of the CO₂ per barrel of crude oil of 450 kilograms, the overall facility/process CO₂ emission 30,000 metric tons, and so forth, and agreement generation module 140 may generate a similar emission monitoring agreement 138 having slightly reduced emission thresholds due to tightening of emission requirements along with a slightly higher annual premium 156 due to the reduced emission threshold and the failure of project 104 to satisfy both of the prior year's thresholds.

In some embodiments, an emission monitoring agreement 138 defines conditional asset distributions based certain conditions, such as a failure to meet certain emission standards. Continuing with the prior example, agreements 138 for the crude oil refining project 104 may define project emission performance terms 152 that correspond to some or all to the emission standards, asset distribution terms 154 that define terms for distribution of assets 160, such emission credits, to one or more members 108 based on failure of performance of the project 104 to satisfy the project emission performance terms 152 or other terms, such as emission risk mitigation strategies required to be performed by the project 104, methods of transferring assets 160, or the like. In some embodiments, a self-executing emission monitoring agreement 139 is an executable version of an emission monitoring agreement 138, having corresponding terms, with the self-executing emission monitoring agreement 139 being defined by computer code that can execute autonomously on, for example, an execution environment, such as a blockchain platform. Continuing with the prior examples described, the emission monitoring agreement 139 may be a self-executing emission monitoring agreement 139 (e.g., a smart contract) that includes code to monitor overall facility/process CO₂ emissions and per barrel CO₂ emissions, and, if overall facility/process CO₂ emission that exceeds the threshold of 25,000 metric tons of CO₂ equivalent per year, to distribute emission credits to offset the overage (with half of the emission credits being distributed to the first member 108 and the other half of the emission credits being distributed to the second member 108), and, if per barrel CO₂ emissions exceeds the threshold of 500 kilograms of CO₂ per barrel of crude oil processed, to distribute emission credits to offset the overage (with the emission credits being distributed to the first member 108), and so forth.

In some embodiment, industry data 130 includes data that is indicative of risk associated with various types of projects, such as potential risks related to regulatory compliance, financial exposure, environmental impact, and project timelines. Industry data 130 may include emission reports, energy consumption data, lifecycle assessments of products, regulatory compliance information, or the like. For example, industry data 130 may include regulatory data, environmental data, historical industry data, financial and market data, social and political data, operational and performance data, or the like. Such data offers a holistic view of the potential financial, regulatory, environmental, and social challenges an environmentally sensitive project may face. By using these varied data sources, a model can assess both the likelihood and impact of different risks, helping project planners and decision-makers take proactive measures to mitigate negative outcomes. For example, a model may use historical data, regulatory data, and geospatial data to identify potential risk areas, use financial, operational, and market data help the model estimate the likelihood of risks materializing, use environmental impact assessments and social data allow the model to predict the severity of consequences if a risk materializes, or the like. This type of comprehensive data training ensures that the risk model can predict a wide array of environmental, financial, and regulatory risks associated with emission-sensitive projects. For example, emission project risk models 134 trained with industry emissions data 130 may provide decision-makers with risk probabilities and financial impacts to guide project design or mitigation strategies for emissions by a project 104 being assessed thereby (a “candidate” project).

Regulatory data can be used for understanding the legal landscape in which a project operates. This may include information on current emission standards, such as limits on CO₂, NOₓ, and particulate matter, as well as regulations regarding waste disposal and resource use. It can also encompass historical compliance records that show how past projects have navigated regulatory challenges. Additionally, it may include regulatory change forecasts that can be valuable in predicting future shifts in environmental laws that may impact the project. This data can helps in determining the legal risks, such as fines or penalties, associated with non-compliance, and anticipates potential future regulations that could alter project costs or timelines. By analyzing how past projects performed, models can estimate the likelihood of cost overruns or delays due to environmental challenges.

Environmental data may focuses on the potential ecological impacts of a project. This may include information from environmental impact assessments (EIAs) that evaluate how a project might affect air, water, soil, and biodiversity. It may include geospatial data that provides location-specific environmental factors, like proximity to sensitive ecosystems, and weather or climate data helps in understanding how local weather patterns could influence project emissions or operational risks. For example, certain climate conditions might lead to higher emissions or require additional mitigations. Incorporating this data may allow models to assess the environmental vulnerabilities and the likelihood of negative impacts on the local ecosystem. Models may use environmental data to predict environmental risks like emissions exceeding limits due to unforeseen factors like climate conditions.

Historical industry data may include data from similar projects that offer insights into what risks might emerge. This may include case studies from past projects, particularly those subject to similar environmental regulations, allowing for a comparison of outcomes, revealing trends in regulatory compliance, financial performance, and environmental impact. Data on incidents such as accidents, regulatory violations, and failures in emission controls provide critical lessons on what can go wrong. Historical cost and overrun data also help the model estimate financial risks, especially in relation to environmental compliance, mitigation efforts, or project delays. Models may analyze performance of past projects to estimate the likelihood of cost overruns or delays due to environmental challenges.

Financial and market data may include data that provides a comprehensive view of the economic landscape in which the project will operate. For example, it may include carbon pricing data that is particularly relevant for projects subject to carbon trading schemes, and that helps estimate costs associated with offsetting emissions. Additionally, financial risk data may include information about the monetary impact of past regulatory violations, such as fines, project shutdowns, and legal fees, providing a clearer picture of the financial stakes. It may also include trends in the cost of mitigation technologies, such as emissions scrubbers or renewable energy solutions, also inform the cost-benefit analysis, helping to evaluate the economic viability of different mitigation strategies. A model may use financial data to assess the economic risks of emission-related costs and the potential market impacts of regulatory penalties.

Social and political data may include data that reflects external pressures that could affect the project. This may include public sentiment towards environmentally sensitive projects, often gathered through surveys, social media analysis, and reports from NGOs, which can influence both regulatory decisions and project timelines. For example, strong public opposition to a project can lead to delays, increased scrutiny, or even regulatory changes. It may also indicate political stability and trends in environmental policy that can be critical, as shifts in political leadership or policy priorities can result in abrupt changes to environmental laws or project approvals. Such data may help anticipate risks arising from the broader socio-political environment. Social and political factors can introduce delays or increase project costs if opposition grows, so this data can be used by a model to help predict the likelihood of such risks.

Operational and performance data may include data that relates to how efficiently a project is likely to run and what that means for its environmental footprint. This may include efficiency metrics, such as energy consumption and waste output rates, provide insights into the day-to-day performance of the project and help assess its potential to stay within emission limits. It may include maintenance and downtime data from similar projects offer an understanding of how often equipment might fail or require repairs, leading to unexpected spikes in emissions or project delays. Such data may help models predict operational risks that could lead to non-compliance with environmental standards and can be used to assess risks related to operational inefficiency that may lead to emission exceedances. A model may use this to assess risks related to operational inefficiency that may lead to emission exceedances.

Industry data sources 130 may include one or more entities that are operable to provide industry data to project management engine 120. Such sources range from governmental agencies to private-sector organizations, each providing vital insights into regulatory, environmental, financial, and operational conditions. In some embodiments an industry data source 130 includes a computer system that is the same or similar to that of computer system 1000 described with regard to at least FIG. 3.

Regulatory data industry data sources 106 may include governmental environmental agencies such as the U.S. Environmental Protection Agency (EPA) and the European Environment Agency (EEA) can be useful, offering information on emission standards, compliance requirements, and enforcement actions. These agencies, along with international bodies like the United Nations Framework Convention on Climate Change (UNFCCC), may supply guidelines on emissions and upcoming regulatory changes, helping to forecast risks associated with evolving environmental laws.

Environmental data industry data sources 106 may include environmental impact assessors, who produce Environmental Impact Assessments (EIAs) for project-specific insights. Geospatial data providers, such as Esri or the U.S. Geological Survey (USGS), offer geographic information on ecosystems, protected areas, and other environmental factors, while organizations like the National Oceanic and Atmospheric Administration (NOAA) and the Intergovernmental Panel on Climate Change (IPCC) supply critical climate data. These resources may help projects account for environmental sensitivities and predict potential ecological impacts.

Historical data industry data sources 106 may include industry reports, white papers, and case studies published by consulting firms, and sector-specific organizations. This may include governmental databases, such as the EPA's Enforcement and Compliance History Online (ECHO), track incidents of regulatory violations, accidents, and environmental failures. It may include insurance companies specializing in environmental liability also providing valuable data on claims, accidents, and the financial impacts of environmental risks.

Financial and market data industry data sources 106, may include carbon pricing platforms like the European Union Emission Trading System (EU ETS) and private markets that provide up-to-date information on carbon offset pricing. This may include financial data providers that track the costs of non-compliance, including fines and shutdowns, and market research firms that offer insights into the costs of emission reduction technologies and the economic feasibility of mitigation strategies.

Social and political data industry data sources 106 may include public opinion surveys conducted by organizations, which measure public sentiment toward environmentally sensitive projects. This may include social media analytics platforms that track online activism and public opinion trends, and political risk analysis firms that provide assessments of political stability, regulatory risk, and policy trends that could influence project outcomes.

Operational and performance data industry data sources 106 may include equipment manufacturers that provide efficiency, energy consumption, and maintenance data for the machinery used in projects. It may include industry associations that publish reports on operational benchmarks and downtime statistics, and databases that offer historical data on the performance and reliability of industrial equipment. Such industry data sources 106 may provide a comprehensive view of the risks and operational challenges associated with environmentally sensitive projects.

In some embodiments, a project risk model 134 is operable to assess industry data 130 and project data 132 for a project 104 and determine a corresponding project risk assessment 136 for the project 104. For example, a project risk model 134 may include an emission risk model that is operable to assess industry emissions data 130 and project data 132 for a project 104 and determine a corresponding project emission risk assessment 136 for the project 104. This may include a prediction of a likelihood that the project 104 will exceed permitted emission limits or fail to meet regulatory standards during its lifecycle. Such a model may integrate data, such as industry data 130 and project data 132, from various sources, such as regulatory guidelines, project-specific operational data, environmental factors, and historical performance of similar projects, to provide a comprehensive evaluation of the potential risks associated with emissions. This may include, for example, indications of predicted direct and indirect emissions, resource consumption, environmental hazards, ability to satisfy regulatory and compliance requirements, and so forth. For example, a project emission risk model 134 may incorporate local, national, and international regulations, such as allowable levels of pollutants like CO₂, NOₓ, and particulate matter, to establish a baseline for assessing whether the project will comply with these emission limits, and incorporates detailed project data 132, including the types of materials, fuels, and processes used, as well as operational efficiency and the effectiveness of mitigation strategies like emissions control systems or renewable energy solutions, to generate a project emission risk assessment 136 for the project 104 that identifies predicted emission generation for the project 104 and identification of predictions of ability to satisfy regulations. Such a model may be useful in determining a prediction of emission violations and associated remedial costs, such as the predicted costs for purchasing emission credits to offset the violations. Such predictions may be used for determining an associated premium for an emission monitoring agreement.

An emission type project risk model 134 (a “project emission risk model”) may incorporate a variety of modeling approaches to assess the risks associated with emissions in environmentally sensitive projects. Such a model may integrate regulatory compliance, environmental impact, operational efficiency, and financial risk. The modeling may employ, for example, deterministic modeling, probabilistic modeling, scenario analysis, predictive modeling, geospatial modeling, environmental and climate modeling, financial and cost-benefit modeling, dynamic systems modeling, machine learning and AI-based models, and sensitivity analysis. Deterministic modeling may involve using fixed input variables to produce a specific outcome without accounting for variability or uncertainty. In the context of emissions, deterministic models may calculate the emissions expected from a project based on known parameters like fuel consumption and emission factors, allowing for straightforward predictions when inputs are well-defined. Probabilistic modeling may incorporate uncertainty. This may include assigning probabilities to different input variables, generating a range of possible outcomes, and may employ techniques like Monte Carlo simulations to help assess the likelihood of different emission scenarios, accounting for variable conditions such as equipment performance or weather. Scenario analysis may be incorporated to explore different hypothetical conditions that could affect a project. For an emission risk model, this may involve simulating the impact of increased production, equipment failures, or regulatory changes, helping planners understand how different scenarios could influence emissions and regulatory compliance. Predictive modeling may be incorporated to leverage historical data to forecast future outcomes. Machine learning algorithms or statistical methods may be incorporated to predict emission trends based on real-time operational data, such as equipment performance or energy use. Such models may anticipate future risks based on patterns observed in similar projects. Geospatial modeling may incorporate geographic data to assess how emissions from a project will disperse in the environment. Such an approach may help understanding the spatial impacts of emissions, particularly how pollutants may affect surrounding communities or ecosystems based on factors like wind direction and terrain. Environmental and climate modeling may be incorporated to determine how environmental conditions, such as local weather patterns or long-term climate trends, affect emissions. For example, extreme weather conditions can lead to unexpected emission spikes, while changes in seasonal temperatures can affect how pollutants disperse or concentrate in the air. Financial and cost-benefit modeling may be incorporated to assess the economic impact of emissions-related risks. Such an approach may evaluate the financial consequences of regulatory fines, the cost of mitigation technologies, and the trade-offs between investing in emission reduction strategies and the financial penalties of non-compliance. Dynamic systems modeling may be incorporated to represent the complex interactions between different variables in a project over time. Such an approach may simulate how operational processes, emission control systems, and environmental factors interact, providing a time-based view of how emissions evolve and how mitigation measures adapt to changing conditions. Machine learning and AI-based models may be employed to incorporate large datasets to predict emission risks and optimize mitigation strategies. These models can improve their accuracy over time by learning from real-time data, making them particularly useful for projects with fluctuating operational parameters that affect emissions. Sensitivity analysis may be incorporated to identify the most influential variables in a model by testing how changes in one or more input factors affect the overall output. In an emission risk model, sensitivity analysis may help determine which factors-such as fuel quality, equipment efficiency, or weather—have the greatest impact on emission levels, guiding efforts to prioritize emission control measures. In some embodiments, a project emission risk model utilizes a combination of different modeling techniques to provide a comprehensive assessment. For example, probabilistic modeling can be incorporated to simulate various operational scenarios, while geospatial and environmental models assess how emissions disperse in the local environment. Machine learning algorithms continuously refine predictions as real-time monitoring data is fed into the system. A financial model calculates the cost of exceeding emission limits, including potential fines and required upgrades to emission control systems. Finally, scenario analysis could simulate the impact of equipment failure, predicting how it would affect emissions and regulatory compliance. Such a combination of modeling approaches may offer a robust tool for managing emission-related risks, ensuring that the project remains within regulatory limits while minimizing financial and environmental impact.

In some embodiments, an asset 160 includes a tangible or intangible item of intrinsic or economic value having ownership that can be transferred from one entity to another. For example, an asset 160 may include physical assets (e.g., goods, equipment, real property or the like), financial assets (e.g., cash, cash equivalents, stocks, bonds, or the like), intangible assets (e.g., intellectual property, emission credits, or the like). Continuing with prior examples, an asset 160 may include an emission credit that is distributed responsive to failure to meet emission standards. An emission credit (also referred to as a “carbon credit”) may be a tradable certificate or permit that represents the right to emit a specific amount of greenhouse gases, typically one metric ton of carbon dioxide (CO₂) or its equivalent in other gases (e.g., 1 Credit=1 Metric Ton of CO₂ or equivalent gases). These credits may be part of emissions trading systems or carbon markets, where companies or organizations are given a certain limit, or cap, on the amount of greenhouse gases they can emit. If a company emits less than their allowance, they can sell their unused credits to other companies that are exceeding their limits, effectively creating a financial incentive for reducing emissions. Accordingly, companies can buy and sell credits, providing a financial mechanism to reduce emissions.

In some embodiments, emission credits may be fractionalized to units smaller than 1 credit. For example, a company owning a single credit, but only expecting to emit ½ metric ton of CO₂ may sell half of the credit to another company only expecting to emit ½ metric ton of CO₂. In some embodiments, emission credits can be pooled and fractionalized. For example, an emission credit supplier may purchase whole or fractional emission credits from various sources to create a pool of emission credits that it can sell or otherwise transfer to other entities in whole or in part (or “fractions”). For example, an emission credit supplier may assemble a pool of 100 emission credits, buying 90 from one entity, 5 from another entity, 3.5 from another entity, and 1.5 from another entity. The emission credit supplier may engage a company expecting to emit 3.5 metric tons of CO₂, and in turn sell or otherwise transfer to the company 3.5 emission credits, including 3 “whole” emission credits and 0.5 fractionalized emission credit. In some embodiments, operator 114 may be or engage with an emission credit supplier to source emission credits for distribution.

Members 108 may include stakeholders in a project. This may include, for example, owners, shareholders, investors, creditors, or the like. Continuing with the prior example, members 108 may include investors or creditors having financial stakes in the crude oil refining process/facility, either through ownership or loans. In such an embodiment, the agreement 138 or 139 may insulate investment by the members 108 by providing a payout of emission credit assets 160 from management system 102 to offset liability that may otherwise be created by emission overruns and violations of the project 104. That is, in return for payment of the premium, deployment of agreement 138 or 139 may shift the financial risk associated with emission violations to management system 102, and away from members 108 and the finances of the project 104.

Monitor 110 may be an independent third party entity responsible for collecting, analyzing, and verifying operational data from a facility or process to ensure it adheres to agreed-upon performance metrics, such as efficiency, emissions, or production targets, and provide corresponding project performance data. As described the project performance data may then be automatically fed into a self-executing agreement (e.g., self-executing emission monitoring agreement 139), a digital contract that enforces predefined actions based on the performance metrics received. Monitor 110 may employ sensors installed or integrated with the process/facility's monitoring systems to gather real-time data on key indicators, such as energy usage or emissions. After collecting the data, monitor 110 may verify its accuracy through cross-referencing with inspections or diagnostic tests, ensuring its reliability. Once verified, monitor 110 may feed data for use by the self-executing agreement, which automatically enforces the contractual terms. For example, consistent with prior examples, if a self-executing emission monitoring agreement 139 requires the facility to keep emissions below a certain threshold, the real-time emissions data is sent to the self-executing agreement. Should emissions exceed the limit, the agreement 139 may trigger actions like distributions of assets (e.g., emission credits) penalties, adjustments in payment, or notifications to relevant stakeholders. Alternatively, if performance metrics are met, the agreement 139 might release payments or adjust terms based on the data. Accordingly, monitor 110 may ensure that the data provided to a self-executing agreement is secure, accurate, and compliant with all regulatory or contractual standards. In some embodiments, monitor 110 includes a computer system that is the same or similar to that of computer system 1000 described with regard to at least FIG. 3.

A project 104 may include an environmentally sensitive project that has significant potential to impact the environment, especially in terms of air, water, or soil quality, biodiversity, and public health. A project 104 may involve industrial processes, energy production, or resource extraction, which, if not properly managed, can result in pollution or ecosystem degradation. A project 104 may be subject to stringent environmental regulations and monitoring, particularly in areas like emissions control, waste management, and resource usage, a such as limits on emission of carbon dioxide (CO₂), nitrogen oxides (NOₓ), sulfur dioxide (SO₂), volatile organic compounds (VOCs), and particulate matter. As described here, a project 104 may involve a crude oil refining process/facility. Although certain embodiments are described in the context of monitoring emission characteristics of a crude oil refining process/facility type project 104 for the purpose of illustration, embodiments may be employed regarding any suitable process, facility, or the like, such as product manufacturing, transportation systems/vehicles, farming, or the like, or any relevant characteristics, such as waste, noise, consumption of resources, or the like.

In some embodiments, project data 132 includes data specific to a corresponding project that is essential for understanding the technical aspects that influence risk of a monitored characteristics, such as emissions. This may include details about the design, materials, and technologies used in the project, such as fuel sources, machinery, and construction methods, all of which contribute to the project's emission profile. It may include process emission data, including factors like the type of fuel or raw materials used, that is necessary to predict how the project will perform under various conditions. The data may include mitigation plans, such as the incorporation of renewable energy technologies or carbon capture systems, help models estimate the project's ability to reduce emissions and manage environmental risks. Project specific data may allow a model to assess operational risks and how the project's specific setup could impact emission levels. Project-specific data may be supplied by a manager of a project (e.g., project manager 112), gathered from engineering firms and contractors who provide details on the technical aspects of the project, such as design, materials, and technologies that affect emissions, industry-specific process data platforms, like those provided by energy companies, that offer emission profiles based on fuel and material usage, environmental consultants that contribute expertise on emission reduction technologies and strategies, or the like.

In some embodiments, project performance data 172 for a process and self-executing agreement includes values or other indications of the performance metrics for the process, on which project performance terms are reliant. For example, where a self-executing emission monitoring agreement 139 is reliant on certain performance metric values for a project 104, project performance data 172 may include data that includes or is otherwise indicative of the performance metrics, and that is generated by a monitor 110 based on associated project operational data 170 obtained for the project 104. Project operational data 170 for a project 104 may include data that is indicative of operation of the project 104. This may include data collected from sensors, internet of things (IoT) devices, satellite imagery, government environmental monitoring stations, company reported data, or the like. For example, in the case of a crude oil refining process/facility, operational data 170 may include exhaust flowrates, temperatures, pressures sources from associated sensors located in the crude oil refining facility, and the associated project performance data 172 may include metrics for annual overall facility/process CO₂ emission, annual average per barrel CO₂ emissions, or the like. In some embodiments, project performance data 172 is a normalized version of corresponding project operational data 170.

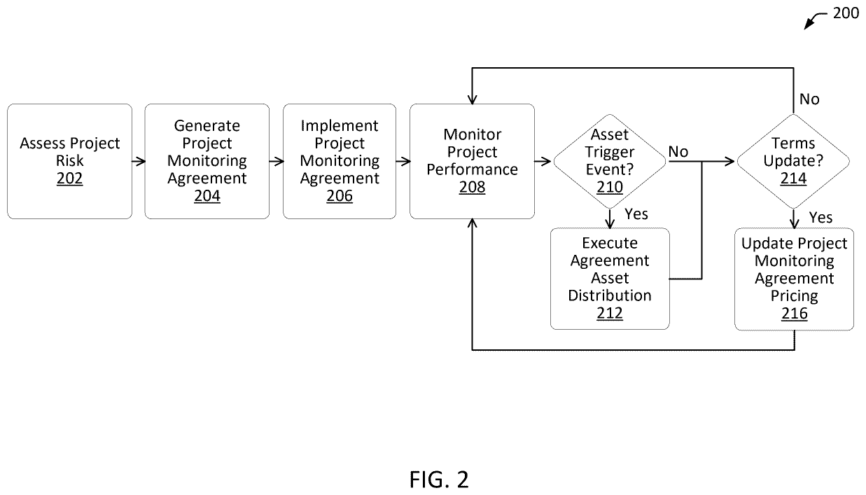

FIG. 2 is a flow diagram that illustrates a method of project management 200 in accordance with one or more embodiments. Some or all of the procedural elements of method 200 may be performed, for example, by project management system 102, emission monitoring platform 122, monitor 110, operator 114, industry data source 106, or another entity.

Method 200 may include assessing project risk (block 202). This may include determining a risk assessment for a project based on project assessment data, including industry source data, project data, or the like. Continuing with the prior example of a crude oil refining process/facility project 104, assessing project risk a may include agreement generation module 140 obtaining industry emissions data 130 from one or more industry data sources 106 that includes historical operational performance data, current government regulations, or the like for crude oil refining processes/facilities, obtaining project data 132 specifying design and operating parameters the crude oil refining process/facility project 104, determining a project emission risk model 134 for crude oil refining processes/facilities based on the industry emissions data 130 obtained, and determining a project emission risk assessment 136 for the project 104 based on application of project data 132 obtained to the project risk model 134 for the crude oil refining processes/facilities project, with the project emission risk assessment 136 including various predictions concerning the crude oil refining process/facility project 104, including predictions regarding emissions by the crude oil refining process/facility project 104, satisfaction of emission regulations, and associated risk, such as financial obligations in the form of monetary liability or emission credits purchases for predicted emission overages, emission mitigation strategies to help satisfy emission requirements, and so forth.

Method 200 may include generating a project monitoring agreement (block 204). This may include generating an emission monitoring agreement, including project performance terms and asset distribution terms, along with an associated agreement premium. Continuing with the prior example, this may include agreement generation module 140 determining an emission monitoring agreement 138 and an associated agreement premium 156. The emission monitoring agreement 138 may, for example, define project performance terms 152 specifying acceptable CO₂ emission limits, including an overall facility/process CO₂ emission limit 25,000 metric tons of CO₂ equivalent per year, a per barrel CO₂ emission limit of 500 kilograms of CO₂ per barrel of crude oil processed, and the like, and asset distribution terms 154 specifying distribution of assets in response to triggering events, including distribution of emission credits to offset overall facility/process CO₂ emission that exceeds the threshold of 25,000 metric tons of CO₂ equivalent per year (with half of the emission credits being distributed to a first member 108 and the other half of the emission credits being distributed to a second member 108), and including distribution of emission credits to offset per barrel CO₂ emission that exceeds the threshold of 500 kilograms of CO₂ per barrel of crude oil processed (with the emission credits being distributed to a first member 108). The corresponding agreement premium 156 may be, for example, $1 million dollars/month to deploy and maintain deployment of the determined emission monitoring agreement 138.

Method 200 may include implementing a project monitoring agreement (block 206). This may include generating a self-executing emission monitoring agreement based on a determined emission monitoring agreement and deploying the self-executing emission monitoring agreement in a suitable execution environment, such as a distributed ledger peer-to-peer (P2P) decentralized network (e.g., a blockchain platform). Continuing with the prior example, implementing a project monitoring agreement may include agreement deployment module 142, in response to receiving an indication of operator 114 receiving payment of the $1 million dollars/month premium for the emission monitoring agreement 138, converting the determined emission monitoring agreement 138 into a self-executing emission monitoring agreement 139 and deploying the self-executing emission monitoring agreement 139 in execution environment 150 (e.g., a block chain platform) of emission monitoring platform 122, with the self-executing emission monitoring agreement 139, being a self-executable version of the determined emission monitoring agreement 138 that includes code to execute terms of the determined emission monitoring agreement 138. For example, the self-executing emission monitoring agreement 139 may be a smart contract that includes code that is executable to monitor overall facility/process CO₂ emissions and per barrel CO₂ emissions, and, if overall facility/process CO₂ emission that exceeds the threshold of 25,000 metric tons of CO₂ equivalent per year, to distribute emission credits to offset the overage (with half of the emission credits being distributed to the first member 108 and the other half of the emission credits being distributed to the second member 108), and, if per barrel CO₂ emissions exceeds the threshold of 500 kilograms of CO₂ per barrel of crude oil processed, to distribute emission credits to offset the overage (with the emission credits being distributed to the first member 108), and so forth. As described, the self-executing emission monitoring agreement 139 may execute autonomously in the execution environment 150 (e.g., on the block chain platform) to monitor conditions concerning terms of the self-executing emission monitoring agreement 139 and automatically execute associated actions to enforce terms of the self-executing emission monitoring agreement 139.

Method 200 may include monitoring project performance (block 208). This may include feeding of project performance data (e.g., including an indication of performance metrics relevant to terms of a self-executing emission monitoring agreement) to an emission monitoring platform hosting execution of the self-executing emission monitoring agreement, and the self-executing emission monitoring agreement assessing the project performance data to determine whether a triggering event has occurred, such as an asset trigger event that will cause the self-executing emission monitoring agreement to cause distribution of an asset to one or more entities. Continuing with the prior example, monitoring project performance may include monitor 110 collecting project emissions operational data 170, including rate of CO₂ emissions and a rate of oil production directly from CO₂ and oil flowrate sensors located in the crude oil refining process/facility of project 104, and determining, based on the collected project emissions operational data 170, corresponding project emissions performance data 172 including, for example, metrics (e.g., quantitative values) for the crude oil refining process/facility project 104, including an overall facility/process CO₂ emission metric of 30,000 metric tons for the past year and a CO₂ per barrel of crude oil processed of 450 kilograms for the past year. Monitor 110 may, in turn, provide the determined project emissions performance data 172 to emission monitoring platform 122, which can act as an oracle to provide relevant project emissions performance data 172 to self-executing emission monitoring agreement 139 for assessment. By way of execution of agreement 139, it may be determined of that the crude oil refining process/facility project 104 satisfied the CO₂ per barrel of crude oil processed requirement (e.g., based on the CO₂ per barrel of crude oil of 450 kilograms being below the 450 kilograms threshold) and that the crude oil refining process/facility project 104 did not satisfy the overall facility/process CO₂ emission requirement (e.g., based on the overall facility/process CO₂ emission 30,000 metric tons being 5,000 metric tons above the 25,000 metric tons threshold). As a result, the failure to satisfy the overall facility/process CO₂ emission requirement may be determined to be an asset distribution trigger event, it may be further determined that 5,000 emission credits are needed to offset the 5,000 metric ton excess emission.

Method 200 may include determining whether an asset trigger event has occurred (block 210). This may include determining whether application of project performance data to project performance terms of a self-executing emission monitoring agreement indicates an event that triggers an associated distribution of an asset. Continuing with the prior example, determining whether an asset trigger event has occurred may include execution of agreement 139 determining that the failure to satisfy the overall facility/process CO₂ emission requirement is an asset distribution trigger event.

Method 200 may include executing an agreement asset distribution (block 212). This may include, in response to determining an asset trigger event pursuant to terms of a self-executing emission monitoring agreement, conducting a corresponding asset distribution in accordance with associated asset distribution terms of the self-executing emission monitoring agreement. Continuing with the prior example, executing an agreement asset distribution may include, by way of execution of the self-executing emission monitoring agreement 139, a distribution (or “payout”) of 2,500 of the emission credits to the first member 108 and the other 2,500 of the emission credits to the second member 108. This may, for example, include an assignment transferring ownership of the 2,500 of the emission credits to the first member 108 and the second member 108. In some embodiments, emission credits (e.g., full or fractional emission credits) may be sourced from a pool of emission credits maintained, or otherwise accessible by, management system 102.

Method 200 may include determining whether agreement term update is required (block 214). This may include determining whether monitoring of project performance has revealed a need to update terms of self-executing emission monitoring agreement. Continuing with the prior example, determining whether agreement term update is required may include agreement generation module 140 supplementing the project data 132 with the project emission operational data 170 and the received project performance data 172 to generate updated project data 132, and retrieving any updated industry data 130, and conducting an updated assessment of assessing project risk and generating a project monitoring agreement (e.g., similar to that described with regard to blocks 202 and 204, using the updated project data 132 and industry emissions data 130) to generate and updated project monitoring agreement and associated premium, and comparing the terms of the updated project monitoring agreement to terms of the current version of the emission monitoring agreement 138 (corresponding to the self-executing emission monitoring agreement 139), and in response to determining that substantive difference exists (e.g., one or more terms are different), implementing the updated project monitoring agreement 138 (e.g., in a manner similar to that described at block 206), which may be followed by execution of the generated corresponding updated self-executing project monitoring agreement 139 (e.g., in a manner similar to that described at blocks 208-216). In some embodiments, this may include determining an updated premium 156 for the updated emission monitoring agreement 138 and requiring payment of the updated premium 156 to deploy the updated emission monitoring agreement 138 as the updated self-executing project monitoring agreement 139.

Such embodiments and associated implementation of a self-executing emission monitoring agreement may insulate investment a project by providing a payout (e.g., a payout of emission credits) that offset liability that may otherwise be created by emission overruns and violations. For example, in return for payment of a premium, deployment of a self-executing emission monitoring agreement may shift financial risks associated with emission violations to an entity to which a premium is paid, and away from finances of the project. This may encourage investment in emission sensitive projects, helping to increase their viability and encourage development and use of emission mitigation strategies.

FIG. 3 is a diagram that illustrates an example computer system (or “system”) 1000 in accordance with one or more embodiments. The system 1000 may include a memory 1004, a processor 1006 and an input/output (I/O) interface 1008. The memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random access memory (SRAM), synchronous dynamic RAM (SDRAM)), or bulk storage memory (e.g., CD-ROM or DVD-ROM, hard drives). The memory 1004 may include a non-transitory computer-readable storage medium having program instructions 1010 stored on the medium. The program instructions 1010 may include program modules 1012 that are executable by a computer processor (e.g., the processor 1006) to cause the functional operations described, such as those described with regard to the entities described (e.g., management system 102, data sources 106, members 108, monitor 110, manager 112, operator 114, project management engine 120, an emission monitoring platform 122, agreement generation module 140, agreement deployment module 142, execution environment 150, or the like), or method 200.

The processor 1006 may be any suitable processor capable of executing program instructions. The processor 1006 may include one or more processors that carry out program instructions (e.g., the program instructions of the program modules 1012) to perform the arithmetical, logical, or input/output operations described. The processor 1006 may include multiple processors that can be grouped into one or more processing cores that each include a group of one or more processors that are used for executing the processing described here, such as the independent parallel processing of partitions (or “sectors”) by different processing cores to generate a simulation of a reservoir. The I/O interface 1008 may provide an interface for communication with one or more I/O devices 1014, such as a joystick, a computer mouse, a keyboard, or a display screen (e.g., an electronic display for displaying a graphical user interface (GUI)). The I/O devices 1014 may include one or more of the user input devices. The I/O devices 1014 may be connected to the I/O interface 1008 by way of a wired connection (e.g., an Industrial Ethernet connection) or a wireless connection (e.g., a Wi-Fi connection). The I/O interface 1008 may provide an interface for communication with one or more external devices 1016, computer systems, servers or electronic communication networks. In some embodiments, the I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
Embodiment 1. An environmental emission reduction system comprising: a project management engine configured to generate self-executing emission monitoring agreements, the project management engine configured to: obtain, from one or more industry data sources, industry emissions data; determine, based on the industry emissions data obtained, one or more project emission risk models configured to determine a project emission risk assessment for a project based on project data for the project; obtain, from a project manager, project data for a project; identify, based on the project data, a project emission risk model of the one or more project emission risk models that corresponds to the project; determine, based on application of the project data obtained to the project emission risk model identified, a project emission risk assessment for the project; and determine, based on the project emission risk assessment for the project, a self-executing emission monitoring agreement for the project, the self-executing emission monitoring agreement defining: project performance terms defining emission metrics for the project; and asset distribution terms defining one or more conditional asset distributions comprising an asset distribution to be conducted responsive to occurrence of an emission asset distribution event, occurrence of the emission asset distribution event determined based on observed values for the monitored emission metrics for the project; and an emission monitoring platform configured to implement self-executing emission monitoring agreements, the emission monitoring platform configured to: obtain, from a project emission monitor, emission performance data for the project, the emission performance data corresponding to observed values of the monitored emission metrics for the project; determine, based on application of the emission performance data obtained to the self-executing emission monitoring agreement, whether an emission asset distribution event has occurred; and distribute, in response to determining that an emission asset distribution event has occurred, an emission asset distribution to one or more member entities.
Embodiment 2. The system of embodiment 1, wherein the self-executing emission monitoring agreement comprises computer code corresponding to the asset distribution terms and comprising conditional statements defining agreement terms corresponding to conducting the emission asset distribution to the one or more member entities in in response to occurrence of the emission asset distribution event.
Embodiment 3. The system of embodiment 2, further comprising the emission monitoring platform configured to: store, on a distributed ledger peer-to-peer decentralized network, the computer code comprising conditional statements defining the conditional asset distributions, wherein the computer code stored on the distributed ledger peer-to-peer decentralized network is configured to be executed to enforce the conditional statements defining the conditional asset distributions.
Embodiment 4. The system of any one of embodiments 1-3, wherein determining an emission asset distribution event has occurred comprises the emission performance data determining that the emission performance data for the project indicates observed values of the monitored emission metrics for the project that fail to satisfy one or more thresholds for the monitored emission metrics for the project, and wherein the emission asset distribution to one or more member entities comprises distribution of an asset having a value corresponding to failure of the observed values to satisfy the one or more thresholds for the monitored emission metrics for the project.
Embodiment 5. The system of embodiment 4, wherein the asset comprises an emission credit.
Embodiment 6. The system of any one of embodiments 1-5, wherein the emission monitor comprises an independent third party entity that is operable to: obtain emission monitoring data corresponding to operational performance of the project; determine, based on assessment of the emission monitoring data, the emission performance data for the project; and provide, to the emission reduction monitoring platform, the emission performance data for use by the self-executing emission monitoring agreement.
Embodiment 7. The system of any one of embodiments 1-6, further comprising a pool of emission credits, wherein the emission asset distribution comprises a fractional emission credit of the pool of emission credits.
Embodiment 8. The system of any one of embodiments 1-7, the project risk assessment for the project comprising a premium to implement the self-executing emission monitoring agreement, and the project management engine further configured to: determine, based on the emissions performance data, updated project data; determine, based on application of the updated project data to the project emission risk model identified, an updated project emission risk assessment for the project; and determine, based on the updated project emission risk assessment for the project, an updated emission monitoring agreement for the project, the updated project emission risk assessment for the project comprising an updated premium to implement the updated emission monitoring agreement, and deploy an updated self-executing updated emission monitoring agreement responsive to receipt of the premium.
Embodiment 9. An environmental emission reduction method comprising: obtaining, from one or more industry data sources, industry emissions data; determining, based on the industry emissions data obtained, one or more project emission risk models configured to determine a project emission risk assessment for a project based on project data for the project; obtaining, from a project manager, project data for a project; identifying, based on the project data, a project emission risk model of the one or more project emission risk models that corresponds to the project; determining, based on application of the project data obtained to the project emission risk model identified, a project emission risk assessment for the project; determining, based on the project emission risk assessment for the project, a self-executing emission monitoring agreement for the project, the self-executing emission monitoring agreement defining: project performance terms defining emission metrics for the project; and asset distribution terms defining one or more conditional asset distributions comprising an asset distribution to be conducted responsive to occurrence of an emission asset distribution event, occurrence of the emission asset distribution event determined based on observed values for the monitored emission metrics for the project; obtaining, from a project emission monitor, emission performance data for the project, the emission performance data corresponding to observed values of the monitored emission metrics for the project; determining, based on application of the emission performance data obtained to the self-executing emission monitoring agreement, whether an emission asset distribution event has occurred; and distributing, in response to determining that an emission asset distribution event has occurred, an emission asset distribution to one or more member entities.
Embodiment 10. The method of embodiment 9, wherein the self-executing emission monitoring agreement comprises computer code corresponding to the asset distribution terms and comprising conditional statements defining agreement terms corresponding to conducting the emission asset distribution to the one or more member entities in in response to occurrence of the emission asset distribution event.
Embodiment 11. The method of embodiment 10, further comprising: storing, on a distributed ledger peer-to-peer decentralized network, the computer code comprising conditional statements defining the conditional asset distributions, wherein the computer code stored on the distributed ledger peer-to-peer decentralized network is configured to be executed to enforce the conditional statements defining the conditional asset distributions.
Embodiment 12. The method of any one of embodiments 9-11, wherein determining an emission asset distribution event has occurred comprises the emission performance data determining that the emission performance data for the project indicates observed values of the monitored emission metrics for the project that fail to satisfy one or more thresholds for the monitored emission metrics for the project, and wherein the emission asset distribution to one or more member entities comprises distribution of an asset having a value corresponding to failure of the observed values to satisfy the one or more thresholds for the monitored emission metrics for the project.
Embodiment 13. The method of embodiment 12, wherein the asset comprises an emission credit.
Embodiment 14. The method of any one of embodiments 9-13, further comprising: obtaining emission monitoring data corresponding to operational performance of the project; determining, based on assessment of the emission monitoring data, the emission performance data for the project; and providing the emission performance data for use by the self-executing emission monitoring agreement.
Embodiment 15. The method of any one of embodiments 9-14, wherein the emission asset distribution comprises a fractional emission credit of the pool of emission credits.
Embodiment 16. The method of any one of embodiments 9-16, the project risk assessment for the project comprising a premium to implement the self-executing emission monitoring agreement, the method further comprising: determining, based on the emissions performance data, updated project data; determining, based on application of the updated project data to the project emission risk model identified, an updated project emission risk assessment for the project; and determining, based on the updated project emission risk assessment for the project, an updated emission monitoring agreement for the project, the updated project emission risk assessment for the project comprising an updated premium to implement the updated emission monitoring agreement, and deploying an updated self-executing updated emission monitoring agreement responsive to receipt of the premium.
Embodiment 17. A non-transitory computer readable medium comprising program instructions stored thereon that are executable by a computer processor to cause the method operations of any one of embodiments 9-16.

What is claimed is:

1. An environmental emission reduction system comprising:
a project management engine configured to generate self-executing emission monitoring agreements, the project management engine configured to:
obtain, from one or more industry data sources, industry emissions data;
determine, based on the industry emissions data obtained, one or more project emission risk models configured to determine a project emission risk assessment for a project based on project data for the project;
obtain, from a project manager, project data for a project;
identify, based on the project data, a project emission risk model of the one or more project emission risk models that corresponds to the project;
determine, based on application of the project data obtained to the project emission risk model identified, a project emission risk assessment for the project; and
determine, based on the project emission risk assessment for the project, a self-executing emission monitoring agreement for the project, the self-executing emission monitoring agreement defining:
project performance terms defining emission metrics for the project; and
asset distribution terms defining one or more conditional asset distributions comprising an asset distribution to be conducted responsive to occurrence of an emission asset distribution event, occurrence of the emission asset distribution event determined based on observed values for the monitored emission metrics for the project; and
an emission monitoring platform configured to implement self-executing emission monitoring agreements, the emission monitoring platform configured to:
obtain, from a project emission monitor, emission performance data for the project, the emission performance data corresponding to observed values of the monitored emission metrics for the project;
determine, based on application of the emission performance data obtained to the self-executing emission monitoring agreement, whether an emission asset distribution event has occurred; and
distribute, in response to determining that an emission asset distribution event has occurred, an emission asset distribution to one or more member entities.

2. The system of claim 1, wherein the self-executing emission monitoring agreement comprises computer code corresponding to the asset distribution terms and comprising conditional statements defining agreement terms corresponding to conducting the emission asset distribution to the one or more member entities in in response to occurrence of the emission asset distribution event.

3. The system of claim 2, further comprising the emission monitoring platform configured to:
store, on a distributed ledger peer-to-peer decentralized network, the computer code comprising conditional statements defining the conditional asset distributions, wherein the computer code stored on the distributed ledger peer-to-peer decentralized network is configured to be executed to enforce the conditional statements defining the conditional asset distributions.

4. The system of claim 1,
wherein determining an emission asset distribution event has occurred comprises the emission performance data determining that the emission performance data for the project indicates observed values of the monitored emission metrics for the project that fail to satisfy one or more thresholds for the monitored emission metrics for the project, and
wherein the emission asset distribution to one or more member entities comprises distribution of an asset having a value corresponding to failure of the observed values to satisfy the one or more thresholds for the monitored emission metrics for the project.

5. The system of claim 4, wherein the asset comprises an emission credit.

6. The system of claim 1, wherein the emission monitor comprises an independent third party entity that is operable to:
obtain emission monitoring data corresponding to operational performance of the project;
determine, based on assessment of the emission monitoring data, the emission performance data for the project; and
provide, to the emission reduction monitoring platform, the emission performance data for use by the self-executing emission monitoring agreement.

7. The system of claim 1, further comprising a pool of emission credits, wherein the emission asset distribution comprises a fractional emission credit of the pool of emission credits.

8. The system of claim 1, the project risk assessment for the project comprising a premium to implement the self-executing emission monitoring agreement, and the project management engine further configured to:
determine, based on the emissions performance data, updated project data;
determine, based on application of the updated project data to the project emission risk model identified, an updated project emission risk assessment for the project; and
determine, based on the updated project emission risk assessment for the project, an updated emission monitoring agreement for the project,
the updated project emission risk assessment for the project comprising an updated premium to implement the updated emission monitoring agreement, and
deploy an updated self-executing updated emission monitoring agreement responsive to receipt of the premium.

9. The system of claim 1, wherein the project emission monitor comprises one or more sensors configured to measure operational parameters of the project, the emission performance data comprising operational parameters measured by the one or more sensors, the operational parameters including at least one of: exhaust flowrate, temperature, pressure, or fuel consumption.

10. The system of claim 1, wherein the emission monitoring platform comprises a distributed ledger execution environment comprising a directed acyclic graph of cryptographic hash pointers, the directed acyclic graph configured to immutably store the self-executing emission monitoring agreement and to enforce execution of the agreement by consensus validation across a plurality of computational nodes.

11. The system of claim 1, wherein the emission monitoring platform further comprises an oracle configured to receive verified emission performance data from an independent monitoring entity and provide the verified data to the self-executing emission monitoring agreement.

12. An environmental emission reduction method comprising:
obtaining, from one or more industry data sources, industry emissions data;
determining, based on the industry emissions data obtained, one or more project emission risk models configured to determine a project emission risk assessment for a project based on project data for the project;
obtaining, from a project manager, project data for a project;
identifying, based on the project data, a project emission risk model of the one or more project emission risk models that corresponds to the project;
determining, based on application of the project data obtained to the project emission risk model identified, a project emission risk assessment for the project;
determining, based on the project emission risk assessment for the project, a self-executing emission monitoring agreement for the project, the self-executing emission monitoring agreement defining:
project performance terms defining emission metrics for the project; and
asset distribution terms defining one or more conditional asset distributions comprising an asset distribution to be conducted responsive to occurrence of an emission asset distribution event, occurrence of the emission asset distribution event determined based on observed values for the monitored emission metrics for the project;
obtaining, from a project emission monitor, emission performance data for the project, the emission performance data corresponding to observed values of the monitored emission metrics for the project;
determining, based on application of the emission performance data obtained to the self-executing emission monitoring agreement, whether an emission asset distribution event has occurred; and
distributing, in response to determining that an emission asset distribution event has occurred, an emission asset distribution to one or more member entities.

13. The method of claim 12, wherein the self-executing emission monitoring agreement comprises computer code corresponding to the asset distribution terms and comprising conditional statements defining agreement terms corresponding to conducting the emission asset distribution to the one or more member entities in in response to occurrence of the emission asset distribution event.

14. The method of claim 13, further comprising:
storing, on a distributed ledger peer-to-peer decentralized network, the computer code comprising conditional statements defining the conditional asset distributions, wherein the computer code stored on the distributed ledger peer-to-peer decentralized network is configured to be executed to enforce the conditional statements defining the conditional asset distributions.

15. The method of claim 12,
wherein determining an emission asset distribution event has occurred comprises the emission performance data determining that the emission performance data for the project indicates observed values of the monitored emission metrics for the project that fail to satisfy one or more thresholds for the monitored emission metrics for the project, and
wherein the emission asset distribution to one or more member entities comprises distribution of an asset having a value corresponding to failure of the observed values to satisfy the one or more thresholds for the monitored emission metrics for the project.

16. The method of claim 15, wherein the asset comprises an emission credit.

17. The method of claim 12, further comprising:
obtaining emission monitoring data corresponding to operational performance of the project;
determining, based on assessment of the emission monitoring data, the emission performance data for the project; and
providing the emission performance data for use by the self-executing emission monitoring agreement.

18. The method of claim 12, wherein the emission asset distribution comprises a fractional emission credit of the pool of emission credits.

19. The method of claim 12, the project risk assessment for the project comprising a premium to implement the self-executing emission monitoring agreement, the method further comprising:
determining, based on the emissions performance data, updated project data;
determining, based on application of the updated project data to the project emission risk model identified, an updated project emission risk assessment for the project; and
determining, based on the updated project emission risk assessment for the project, an updated emission monitoring agreement for the project,
the updated project emission risk assessment for the project comprising an updated premium to implement the updated emission monitoring agreement, and
deploying an updated self-executing updated emission monitoring agreement responsive to receipt of the premium.

20. A non-transitory computer readable medium comprising program instructions stored thereon that are executable by a computer processor to cause the following operations for environmental emission reduction:
obtaining, from one or more industry data sources, industry emissions data;
determining, based on the industry emissions data obtained, one or more project emission risk models configured to determine a project emission risk assessment for a project based on project data for the project;
obtaining, from a project manager, project data for a project;
identifying, based on the project data, a project emission risk model of the one or more project emission risk models that corresponds to the project;
determining, based on application of the project data obtained to the project emission risk model identified, a project emission risk assessment for the project;
determining, based on the project emission risk assessment for the project, a self-executing emission monitoring agreement for the project, the self-executing emission monitoring agreement defining:
project performance terms defining emission metrics for the project; and
asset distribution terms defining one or more conditional asset distributions comprising an asset distribution to be conducted responsive to occurrence of an emission asset distribution event, occurrence of the emission asset distribution event determined based on observed values for the monitored emission metrics for the project;
obtaining, from a project emission monitor, emission performance data for the project, the emission performance data corresponding to observed values of the monitored emission metrics for the project;
determining, based on application of the emission performance data obtained to the self-executing emission monitoring agreement, whether an emission asset distribution event has occurred; and
distributing, in response to determining that an emission asset distribution event has occurred, an emission asset distribution to one or more member entities.
